(19) United States
(12) Patent Application Publication
(10) Pub. No.: US 2024/0098070 A1
(43) Pub. Date: Mar. 21, 2024

(54) SECURE TRANSMISSION OF CONTENT UPDATES VIA SUPERDENSE CODING

(71) Applicant: Red Hat, Inc., Raleigh, NC (US)

(72) Inventors: Leigh Griffin, Waterford (IE); Stephen Coady, Waterford (IE)

(21) Appl. No.: 17/945,531

(22) Filed: Sep. 15, 2022

(51) Int. Cl. H04L 9/40; G06F 8/65; G06F 21/57; G06N 10/80

(52) U.S. Cl. CPC H04L 63/0428; G06F 8/65; G06F 21/572; G06N 10/80; G06F 2221/034

(57) ABSTRACT

A method for updating content is disclosed that includes receiving, by a first quantum computing device (QD), a classical encoding of an update for content. The classical encoding is stored in a first set of bits with a first cardinality. The content is stored on a first classical computing device (CD) that is enabled to update the content via a patching protocol. In response to receiving the classical encoding, the first QD causes a transmission of the classical encoding. The transmission of the classical encoding includes transmitting a first set of qubits that have a second cardinality that is less than the first cardinality. Quantum states of the first set of qubits store a quantum-mechanical (QM) encoding of the update. The QM encoding of the update was generated based on a superdense coding protocol.

### BACKGROUND

Quantum computing involves the use of quantum bits, referred to herein as “qubits,” which have characteristics that differ from those of classical (i.e., non-quantum) bits used in classical computing. Qubits may be employed by quantum services that are executed by quantum computing devices. As quantum computing continues to increase in popularity and become more commonplace, an ability to efficiently and accurately allocate qubits in real time will be desirable.

### SUMMARY

The examples disclosed herein provide updates for content. The content may include but is not necessarily limited to executable applications and operating systems (OS). The updates may be in the form of a patch update and/or patch upgrade. The update may be a security patch. To reduce the required bandwidth to transmit the patch update, and to reduce security concerns, the patch update may be encoded in qubits via superdense coding. The transmission of qubits, rather than classical bits, is inherently more secure and ensures the privacy of the transmitted data.

One embodiment includes a method for updating content. The method includes receiving, by a first quantum computing device (QD), a classical encoding of an update for the content. The classical encoding may be stored in a first set of bits that has a first cardinality. The content may be stored on a first classical computing device (CD) that is enabled to update the content by employing a patching protocol that receives, as input, the classical encoding of the update. The method may further include, and in response to receiving the classical encoding of the update for the content, causing, by the first QD, a transmission of the classical encoding of the update to the first CD. The transmission of the classical encoding includes transmitting a first set of qubits. The first set of qubits may have a second cardinality that is less than the first cardinality of the first set of bits. Quantum states of the first set of qubits may store a quantum-mechanical (QM) encoding of the update for the content. The QM encoding of the update may have been generated based on a superdense coding protocol and the classical encoding.

Another embodiment includes another method for updating content. The other method includes receiving, by a first quantum computing device (QD), a quantum-mechanical (QM) encoding of an update for content. The QM encoding may be stored in quantum states of a first set of qubits. The first set of qubits may have a first cardinality. The content may be stored on a first classical computing device (CD). The first CD may be enabled to update the content by employing a patching protocol that receives, as input, a classical encoding of the update. The other method may further include, and in response to receiving the QM encoding of the update for the content, causing, by the first QD, a transmission of the classical encoding of the update to the first CD. The transmission of the classical encoding may include transmitting a first set of bits. The first set of bits may have a second cardinality. The second cardinality may be greater than the first cardinality of the first set of qubits. The first set of bits may store the classical encoding of the update for the content. The classical encoding of the update may have been generated based on a superdense coding protocol and the QM encoding.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a quantum computing device, which may be employed to practice example embodiments;

FIG. 2 is a block diagram of a content distribution environment that is consistent with various embodiments;

FIGS. 3A-3B provide a flowchart for a method for updating content via superdense coding that is consistent with various embodiments;

FIG. 4 is a simpler block diagram of the quantum computing device 10 of FIG. 1 for providing updates for content via superdense coding, according to one example;

FIG. 5A provides a flowchart of a simplified method for providing updates for content via superdense coding, according to one example; and

FIG. 5B provides a flowchart of another simplified method for providing updates for content via superdense coding, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first executing quantum service” and “second executing quantum service,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

Quantum computing and quantum information processing involve the use of quantum bits, referred to herein as “qubits,” which have characteristics that differ from those of classical (i.e., non-quantum) bits used in classical computing. Qubits may be employed by quantum services that are executed by quantum computing devices. The embodiments employ a quantum mechanical mechanism referred to as superdense coding (or superdense encoding). Briefly, superdense coding is quantum communication protocol that enables a transmission of multiple classical bits of information, via the transmission of a smaller number of qubits along a quantum communication channel. For instance, two classical bits of information may be transmitted from a sender (e.g., Alice) to a receiver (e.g., Bob) via the sending of a single qubit (e.g., from Alice to Bob) along a quantum communication channel (QCC). Thus, as a quantum communication protocol, superdense coding enables the transmission of at least twice the amount of information than that as classical communication protocols for equivalent numbers of qubits and classical bits. It may be said that superdense coding is an inverse process of quantum teleportation.

The quantum state of the single qubit transmitted along the QCC may be a superposition of the two eigenstates of the quantum computing system (QCS) and/or quantum computing device (QD) employed by the sender and receiver. It is noted that, when a qubit is a state of superposition and is transmitted along a QCC, the QCC is inherently secure from eavesdropping. That is, in contrast to classical communication channels (CCC), the transmission of the information transmitted via the quantum state of the qubit (e.g., at least two classical bits of information) is inherently safe from “man-in-the-middle” attack vectors, which may be positioned along the QCC and between the sender and receiver.

The embodiments are directed to superdense patch distribution (SPD) services for content updates. The content may include, but is not limited to, executable applications, operating systems (OS), firmware, video files, audio files, text-based files, image files, and/or other documents. An update (e.g., a security patch) for the content may be sent from a content creator/distributor (e.g., a content distribution server) to a content consumer (e.g., a user and/or a client of the distribution server), via superdense coding of classical information associated with the update. The content distributor may encode classical information for the “patch” via qubits, in accordance with various superdense coding protocols. The encoding qubits may be transmitted from the distributor (e.g., Alice) to the client (e.g., Bob) via a QCC. The client may de-code the encoding qubits via the various superdense coding protocols. De-coding the qubits may include “measuring” the quantum states of the transmitted qubits (via the superdense coding protocols) to interpret the classical information encoded in the qubits and storing the information in classical bit via a patch file. Upon decoding, the client may generate a “patch” file (e.g., a security patch file) and update the content (e.g., an application or OS) via the decoded patch. Because the coding is “superdense,” fewer qubits need to be transmitted along the QCC than the number of classical bits than would otherwise be needed to be transmitted if the patch was classically transmitted along a CCC. Furthermore, because the QCC is inherently safe from eavesdropping by a “man-in-the-middle,” the transmission of the patch information is secure and private between the distributor and the client.

More particularly, the embodiments leverage superdense coding to decrease the number of bits required to be sent by a classical network (e.g., CCC) for a patch update. In various embodiments, the reduction is by at least a factor of two. The embodiments also ensure that the transmitted information (e.g., transmitted via qubits along a QCC) is unreadable by a “man-in-the-middle” along the QCC. For instance, the principles of quantum mechanics stipulate that on average, half of the transmitted qubits are unreadable by a “man-in-the-middle.” Furthermore, the “man-in-the-middle” would have no knowledge of which half of the qubits are unreadable, which significantly increases the difficulty in reverse engineering the data stream. The embodiments employ superdense quantum communication drivers (QCD) to encode and decode patches via the superdense coding protocols. A QCD may be enabled to receive a classical file, translate classical information encoded in the file, and encode the classical information in a set of qubits, via a superdense coding protocol. A QCD may be further enabled to receive a set a set of qubits, measure the quantum states of the qubits to decode the information encoded in the qubits via a superdense coding protocol, and generate a classical file encoding the decoded information. A QCD may be implemented by a quantum computing device (QD) and/or a quantum computing system (QCS).

Each of the distributor and client may have an implementation of a QCD at their respective physical locations. The two QCDs are communicatively coupled via a QCC. A QCD may deploy both quantum and classical services. That is, a pair of QCDs employ both classical and quantum services to communicate using superdense coding and to create a secure channel for the delivery of content between services. The patch files are encoded via superdense coding protocols, stored, and later decoded.

An author at the distributor may author an update patch (e.g., a security patch). The patch may be authored in any programming language. The patch may be encoded classically in a bit-based file. The classical file is provided to a superdense patch distributor (SPD) located at the distributor. The distributor's QD may additionally implement a QCD. The combination of the SPD and the QCD at the distributor may be included in a content distribution network (CDN) of the distributor. In addition to a QCD and an SPD, the CDN may include one or more QCCs, that communicatively couple the distributor to one or more clients, via quantum-means. The distributor may employ the CDN to provide its clients content, as well as patch updates to the content.

The distributor's QCD receives the classical file from its author. The distributor's QCD may perform a superdense translation (e.g., a decoding via a measurement of the quantum states of the qubits). During the translation, the classical file is transformed into a superdense encoded file. The superdense file is encoded via qubits, rather than classical bits. The qubits encoding the superdense (or quantum) file are in a superposition of eigenstates. Thus, on-average, half of the information content is obscured through the nature of the translation and stored locally in qubits that are made available to the SPD. The distributor's CDN may employ the SPD to distribute the patch file to one or more clients' via the CDN's QCC.

Aspects of the present disclosure provide a number of technical effects and benefits. For instance, the update patch can be made available to services ahead of time with no risk of exposure. That is, the superdense coded qubits may be made available and/or transferred (via the QCC) to a client. The client's QCD may decrypt the transferred qubits. Various embodiments employ the distributor's QCD to complement the client's QCD and enables a secure QCC for the distribution of the patch and provide a more provably secure way to distribute content updates.

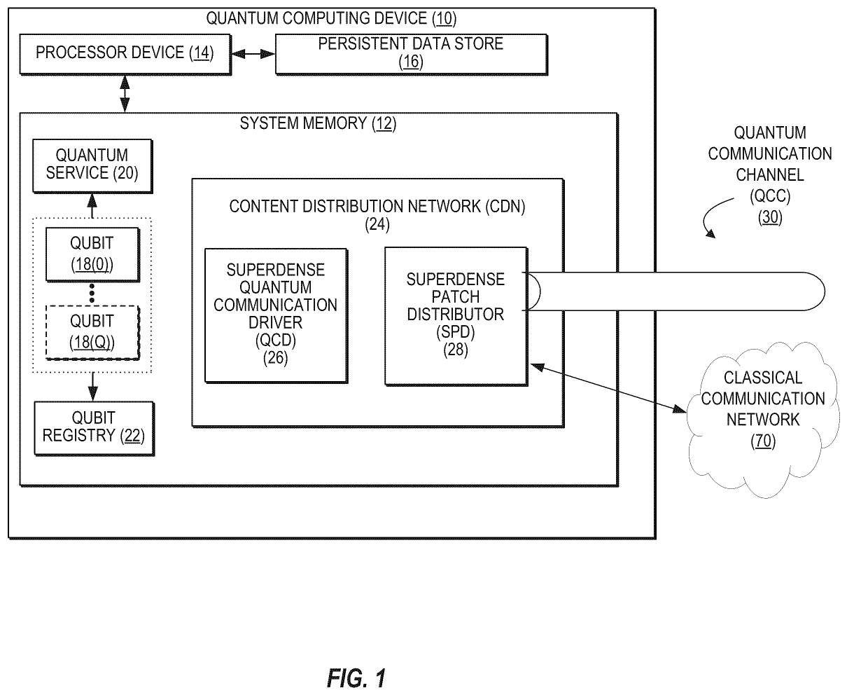

FIG. 1 is a block diagram of a quantum computing device 10 that comprises a system memory 12 and a processor device 14. The quantum computing device 10 further comprises a persistent data store 16 (e.g., a hard drive or Solid State Drive (SSD), as non-limiting examples). It is to be understood that the quantum computing device 10 in some examples may include constituent elements in addition to those illustrated in FIG. 1. The quantum computing device 10 operates in quantum environments but is capable of operating using classical computing principles or quantum computing principles. Thus, in some implementations, portions of the quantum computing device 10 (e.g., the content distribution network (CDN) 242 and/or the superdense patch distributor (SPD) 28 described further herein) may be executed using classical computing components and/or algorithms.

When using quantum computing principles, the quantum computing device 10 performs computations that utilize quantum-mechanical phenomena, such as superposition and/or entanglement states. The quantum computing device 10 may operate under certain environmental conditions, such as at or near zero degrees (0°) Kelvin. When using classical computing principles, the quantum computing device 10 utilizes binary digits that have a value of either zero (0) or one (1).

In the example of FIG. 1, the quantum computing device 10 implements a set of one or more qubits 18(0)-18(Q) for use by quantum services executed by the quantum computing device 10. To maintain information for the qubit(s) 18(0)-18(Q), the quantum computing device 10 includes a qubit registry 22. The qubit registry 22 maintains and provides access to data relating to the qubits implemented by the quantum computing device 10, such as a count of the total number of qubits implemented by the quantum computing device 10 and a count of the number of available qubits that are currently available for allocation, as non-limiting examples. The qubit registry 22 also stores qubit metadata (not shown) for a corresponding qubit. The qubit metadata may include, as non-limiting examples, an identifier of the corresponding qubit, an availability indicator that indicates whether the corresponding qubit is available for use or is in use by a specific quantum service, an identifier of a quantum service that is associated with the corresponding qubit or to which the corresponding qubit is allocated, and/or an quantum phenomena indicator that indicates whether the corresponding qubit is in an entangled state and/or a superposition state.

The quantum computing device 10 of FIG. 1 executes one or more quantum services, such as the quantum service 20. The quantum service 20 may be a process that employ qubits such as the one or more qubits 18(0)-18(Q) to provide desired functionality.

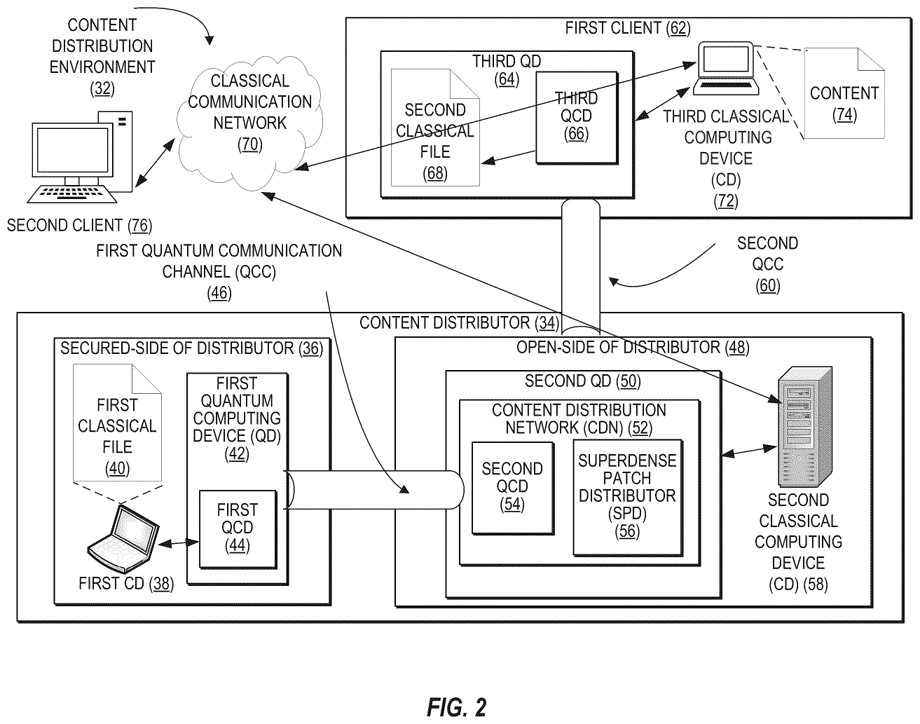

The quantum computing device 10 of FIG. 1 implements a content distribution network (CDN) 24. A content distributor (e.g., content distributor 34 Of FIG. 2) may employ the CDN 24 to distribute content (e.g., applications and operating systems (OS)) and updates for the content (e.g., patch update files) to one or more clients. The CDN 24 may include a superdense quantum communication driver (QCD) 26, a superdense patch distributor (28), and a quantum communication channel (30). In some embodiments, the CDN 24 may additionally include a classical communication network 70 (e.g., a classical communication channel (CCC)). The CDN 24 may provide content and patch updates via superdense coding of qubits along the QCC 300. When the bandwidth reduction concerns and/or security issues do not require the benefits of superdense coding and quantum communication protocols, the classical communication network 70 may be employed to provide the content and content updates.

The QCD 26 may be enabled to receive a classical file, translate classical information encoded in the file, and encode the classical information in a set of qubits, via a superdense coding protocol. The QCD 26 may be further enabled to receive a set a set of qubits, measure the quantum states of the qubits to decode the information encoded in the qubits via a superdense coding protocol, and generate a classical file encoding the decoded information. The SPD 28 may be enabled to coordinate, manage, and/or oversee the distribution of content and content updates to one or more clients, as well as the operations of the QCD 26. The CQQ 30 may be enabled to transmit superdense coding qubits to one clients of the CDN 24.

It is to be understood that, because the CDN 24 is a component of the quantum computing device 10, functionality implemented by the CDN 24 may be attributed to the quantum computing device 10 generally. Moreover, in examples where the CDN 24 comprises software instructions that program the processor device 14 to carry out functionality discussed herein, functionality implemented by the CDN 24 may be attributed herein to the processor device 14. It is to be further understood that while, for purposes of illustration only, the QCD 26 and/or the SPD 28 are depicted as a single components, the functionality implemented by the QCD 26 and/or the SPD 282 may be implemented in any number of components, and the examples discussed herein are not limited to any particular number of components.

FIG. 2 is a block diagram of a content distribution environment (CDE) 32 that is consistent with various embodiments. The CDE 32 may include a content distributor 34 and at least a first client 62 of the content distributor 34. In various embodiments, the CDE 32 may include additional clients of the content distributor 34 (e.g., second client 76). The content distributor 34 may include a secured-side 36 of the distributor 34 and an open-side 48 of the distributor 34. As the names implies, the secured-side 36 may be communicatively coupled only to the open-side 48, while the open-side 48 may be communicatively coupled to clients of the distributor 34 (e.g., the first client 62 and the second client 76). More specifically, the secured-side 36 of the distributor 34 may be communicatively coupled to the open-side 48 of the distributor 34 through a first quantum communication channel (QCC) 46. As noted throughout, the first QCC 46 is inherently secure from “man-in-the-middle” attack vectors. Thus, other than being communicatively coupled to the open-side 48 of the distributor 34, the secured-side 36 of the distributor of 34 may be communicatively isolated from the rest of the universe, e.g., the secured-side 36 of the distributor 34 is not connected to a classical communication network, such as classical communication network 70.

The secured-side 36 of the distributor 34 may include a first quantum computing device (QD) 42 and a first classical computing device (CD) 38. The open-side 48 of the distributor 34 may include a second QD 50 and a second CD 58. The first client may include a third QD 64 and a third CD 72. A first party (e.g., the content distributor 34) may operate each of the first QD 42, the second QD 50, the first CD 38, and the second CD 58, while a second party (e.g., the first client 62) operates the third QD 66 and the third CD 72.

Each of the first QD 42, the second QD 50, and the third QD 64 may be equivalent and/or similar to the quantum computing device 10 of FIG. 1. As such, the first QD 42 may include a first superdense quantum communication driver (QCD) 44, the second QD 50 may include a second QCD 54, and the third QD 64 may include a third QCD 66. Each of the first QCD 44, the second QCD 54, and the third QCD 66 may be equivalent and/or similar to QCD 26 of FIG. 1.

More specifically, the second QD 50 may implement a content distribution network (CDN) C52. The CDN 52 may be equivalent and/or similar to the CDN 24 of FIG. 1. As such, CDN 52 may employ and/or include the second QCD 54 and a superdense patch distributor (SPD) 56. SPD 56 may be equivalent and or similar to SPD 28 of FIG. 1. The first QCD 44 may be communicatively coupled to the second QCD 54 and the SPD 56, via the first QCC 46. The second QCD 54 and the SPD 56 may be communicatively coupled to the third QD 64 and third QCD 66 of first client 62, via a second QCC 60.

The third CD 72 (of the first client 62) may include, implement, and/or execute content 74. Content 74 may be, but is not otherwise limited to an executable application or an operating system (OS). The third CD 72 of the first client 62, the second CD 58 of the open-side 50 of the contentdistributor 34, and a fourth CD of the second client 76 may be communicatively coupled, via the classical communication network 70 (e.g., a classical communication channel (CCC) that employs classical communication means and protocols that are enabled via bits). Although not shown explicitly in FIG. 2, the second client 76 may also implement content 74. As indicated by the double arrows, the first CD 38 may be communicatively coupled to the first QD 42 (via classical means), the second CD 58 may be communicatively coupled to the second QD (50) (via classical means), and the third QD 64 may be communicatively coupled to the third CD 72 (via classical means).

Note that the secured-side 36 of the distributor 34 may be secure at least because the first CD 38 is isolated from the classical communication network 70. That is, the secured-side 36 may be enabled to communicate only with the open-side 48 by transmitting qubits between the first QD 42 and the second QD 50, via the inherently secure first QCC 46. That is, the only means of communication from the secured-side 36 are quantum-mechanical communication means (e.g., transmission of qubits). Because the classical computing devices cannot communicate via quantum-mechanical communication means, the first CD 38 is communicatively isolated from devices of the content distribution environment 32, except for the first QD 42. Note that the first QD 42 is indirectly communicatively coupled to the third QD 66, only through quantum-mechanical communication means, via the first QCC 46 and the second QCC 60. In some embodiments not shown in FIG. 2, a third QCC may directly communicatively couple, though quantum-mechanical communication means, the first QD 42 to the third QD 66. Also note that because the second QD 50 is classically communicatively coupled to the second CD 58, which is communicatively coupled to the classical communication network 70, the classical communication network 70 communicatively couples the second QD 50 to the third CD 72.

In various embodiments, a content author may employ the communicative isolated third CD 38 to author an update (e.g., a patch) for the content 74. The update for the content 74 may include a security patch for the content 74. The update may be classically encoded (e.g., via bits) in a first classical file 40. That is, the first classical file 40 may include a classical encoding of an update for the content 74. The classical encoding may be stored in bits of the first classical file 40. The third CD 72 may be enabled to update the content 74 by employing a patching protocol that receives, as input, the classical encoding of the update. The first classical file 40 may be provided to the first QCD 44 of the first QD 42 via classical means. In response to receiving the classical encoding of the update for the content 74, the first QD 42 is enabled to cause a transmission of the classical encoding of the update to the third CD 72. The transmission of the classical encoding may include transmitting a set of qubits. The transmitted set of qubits may store a quantum-mechanical (QM) encoding of the update for the content 74. The first QCD 44 may generate the QM encoding of the update based on a superdense coding protocol and the classical encoding of the update. The first QCD 44 may generate the QM encoding of the update for the content 74 by preparing quantum states of the set of qubits based on the superdense coding protocol such that the quantum states of the first set of qubits store the QM encoding of the update.

In some embodiments, the set of qubits are transmitted from the first QD 42 to the second QCD 54 of the second QD 50 via the first QCC 46. That is, causing transmission of the classical encoding of the update to the third CD 72 may include transmitting, over the first QCC 46, the set of qubits from the first QD 42 to the second QD 50. In such embodiments, the first QD 42 prepared the quantum states of the set of qubits and the second QD 50 is enabled to cause the transmission of the classical encoding of the update to the third CD 72, via the SPD 56.

In other embodiments, the set of qubits are indirectly transmitted to the third QCD 66 of the third QD 64 via a combination of the first QCC 46 and the second QCC 60. That is, the second QD 50 may serve as a “relayer” or “repeater” for the transmission of qubits between the first QD 42 and the third QD 64. The SPD 56 is enabled to operate and/or manage this “relayer” functionality. In still other embodiments, the set of qubits are directly transmitted to the third QCD 66 of the third QD 64 via a third QCC (not shown in FIG. 2) that directly couples the first QD 42 to the third QD 64. In at least one embodiment, the second QCD 54 may prepare quantum states of a second set of qubits such that the second set of qubits stores the QM encoding of the update for the content 74. In this embodiment, the second QD 50 (via the SPD 56) may transmit the second set of qubits to the third QD 64, via the second QCC 60.

In these various embodiments, the third QCD 66 of the third QD 64 is enabled to decode the QM encoding of the update for the content 74, via the superdense coding protocol. The third QCD 66 is enabled to generate a second classical file 68 that stores the classical encoding of the update. The third QD 64 may transmit (via classical means) the classical encoding of the update to the third CD 72 by providing the second classical file 68 to the third CD 72. Note that the set of bits that store the classical encoding of the update in the first classical file 40 may be equivalent to the set of bits that store the classical encoding of the update in the second classical file 68. Because the superdense coding protocol was employed, a cardinality of the transmitted set of qubits (which store the QM encoding of the update) may be less than a cardinality of the set of bits (of either the first classical file 40 or the second classical file 68) that store the classical encoding of the update. In various embodiments, the cardinality of the set of bits may be twice the cardinality. That is, the cardinality of the set of qubits is one-half the cardinality of the set of bits.

In various embodiments, the second QCD 54 may generate a third classical file not shown in FIG. 2. The third classical file may store the classical encoding of the update for the content 74. That is, the second QCD 54 and/or the SPD 56 may decode the qubits transmitted from the first QD 42 by measuring the quantum states of the qubits based on the superdense coding protocol. The SPD 56 may provide the third classical file to the second CD 58. The second CD 58 may provide the third classical file (e.g., a patch file) to the second client 76, via the classical communication network. For example, if the second client 76 does not have the security concerns as the first client 62 and/or the network bandwidth of the second client 76 is such that the reduction in required bits is not needed by the second client 76, the patch updates may be transmitted to the second client 76 via classical means.

As discussed above, in various embodiments, the third QD 64 may receive the QM encoding of the update for content 74. The QM encoding may be stored in quantum states of the first set of qubits received via the second QCC 60. The content 74 is stored (or implemented) at the third CD 72. The third CD 72 is enabled to update the content 74 by employing a patching protocol that receives, as input, a classical encoding of the update. In response to receiving the QM encoding of the update for the content 74, the third QD 64 may cause a transmission of the classical encoding of the update to the third CD 72. The transmission of the classical encoding may include transmitting a set of bits that store the classical encoding of the update for the content 74. The set of classical bits may be stored in the second classical file 68. The third QCD 66 may generate the classical encoding of the update based on a superdense coding protocol and the received QM encoding. Generating the classical encoding of the update for the content 74 may be based on the superdense coding protocol and the QM encoding stored in the received set of qubits. Generating the classical encoding may include receiving the set of qubits at the third QCD 66 and from the second QCC 60 and/or the second QD 50. The quantum states of the received set of qubits may be measured at the third QD 64. Measuring the quantum states of the set of qubits may be based on the superdense protocol.

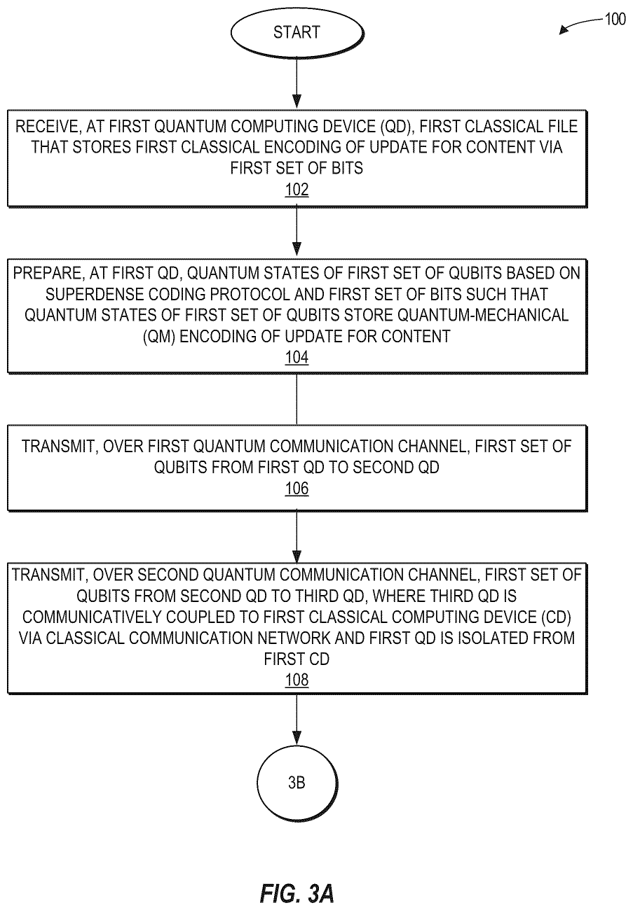

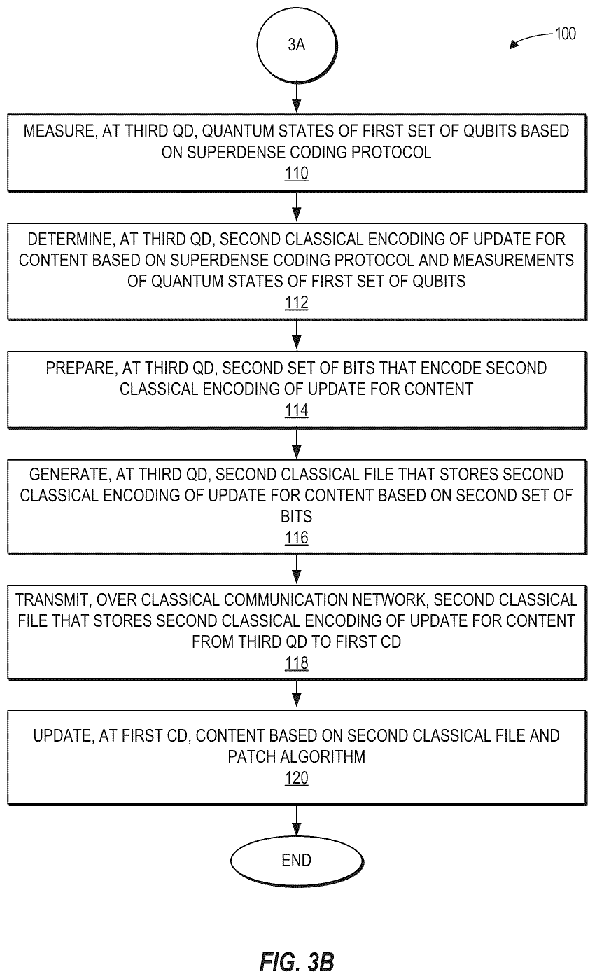

To illustrate exemplary operations performed by the quantum computing device 10 of FIG. 1 and/or within the content distribution environment (CDE) 32 of FIG. 2 for providing updates (e.g., patch files) for content via superdense coding, FIGS. 3A-3B provide a flowchart for a method 100. Elements of FIGS. 1-2 are referenced in describing FIGS. 3A-3B for the sake of clarity. Method 100 begins, after a start block, at block 102, where a first classical file (e.g., first classical file 40 of FIG. 2) is received at a first quantum computing device (QD) (e.g., first QD 42 of FIG. 2). The first classical fil may stores a classical encoding of an update for content (e.g., content 74 of FIG. 2), via a first set of bits.

At block 104, quantum states of a first set of qubits may be prepared based on a superdense coding protocol and the first set of bits. Once prepared, the quantum states of the first set of qubits may store a quantum-mechanical (QM) encoding of the update for the content. At block 106, the first set of qubits may be transmitted over a first quantum communication channel (QCC) (e.g., first QCC 46 of FIG. 2). The first set of qubits may be transmitted from the first QD to a second QD (e.g., second QD 50 of FIG. 2). At block 108, the first set of qubits may be transmitted over a second QCC (e.g., second QCC 60 of FIG. 2). The first set of qubits may be transmitted from the second QD to a third QD (e.g., third QD 66 of FIG. 2). The third QD may be communicatively coupled to a first classical computing device (CD) (e.g., third CD 72 of FIG. 2) via a classical communication network (e.g., classical communication network 70 of FIG. 2). The first QD may be communicatively isolated from the first CD.

At block 110 (of FIG. 3B), the quantum states of the first set of qubits may be measured at the third QD. Measuring the quantum states of the first set of qubits may be based on the superdense coding protocol. At block 112, a second classical encoding of the update for the content may be determined at the third QD. Determining the second classical encoding of the update may be based on the superdense coding protocol and the measurements of the quantum states of the first set of qubits. Note that the second classical encoding of the update may be equivalent and/or similar to the first classical encoding of the update. At block 114, a second set of bits may be prepared at the third QD. The second set of bits may store and/or encode the second classical encoding of the update for the content. At block 116, a second classical file (e.g., second classical file 68 of FIG. 2) may be generated at the third QD. The second classical file may store the second classical encoding of the update for the content based on the second set of bits. Note that the second classical file may be equivalent and/or similar to the first classical file. At block 118, via a classical communication network and/or classical communication means, the second classical file that stores the second classical encoding of the update is transmitted from the third QD to the first CD. At block 120, the content is updated at the first CD based on the second classical file and a patch algorithm and/or protocol.

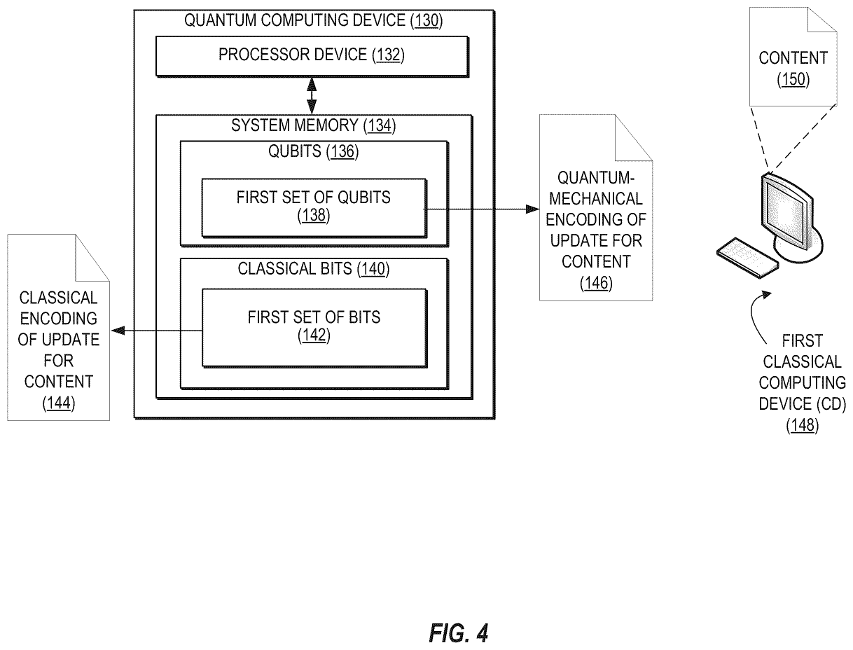

FIG. 4 is a simpler block diagram of the quantum computing device 10 of FIG. 1 for providing updates for content via superdense coding, according to one example. In the example of FIG. 4, a quantum computing device 130 comprises a system memory 134 and a processor device 132. A first portion of the system memory 134 may be implemented by qubits 136. The qubits 136 may include a first set of qubits 138. The first set of qubits 138 has a second cardinality. A second portion of the system memory may be implemented by classical bits 140. The classical bits 140 may include a first set of qubits. Also shown in FIG. 4 is a first classical computing device (CD) 148 stores content 150.

In one embodiment, the processor device 132 is communicatively coupled to the system memory 134 such that the processor device 132 receives a classical encoding 144 of an update for content 150. The classical encoding 144 is stored in the first set of bits 142. The first set of bits 142 has a first cardinality that is greater than the second cardinality of the first set of qubits 138. The content 150 is stored on a first CD 148. The first CD 148 is enabled to update the content 150 by employing a patching protocol that receives, as input, the classical encoding 144 of the update. In response to receiving the classical encoding 144 of the update for the content 150, the processor device 132 causes a transmission of the classical encoding 144 of the update to the first CD 148. The transmission of the classical encoding 144 includes transmitting the first set of qubits 138. Quantum states of the first set of qubits 138 store a quantum-mechanical (QM) encoding 146 of the update for the content 150. The QM encoding 146 of the update was generated based on a superdense coding protocol and the classical encoding 144.

In another embodiment, the processor device 132 is communicatively coupled to the system memory 134 such that the processor device 132 receives the QM encoding 144 of the update for content 150. In response to receiving the QM encoding 144 of the update for the content 150, the processor device 132 causes a transmission of the classical encoding 144 of the update to the first CD 148. The transmission of the classical encoding 144 includes transmitting the first set of bits 142. The cardinality of the first set of bits 142 is greater than the cardinality of the first set of qubits 138. The first set of bits 142 store the classical encoding 144 of the update for the content 150. The classical encoding 144 of the update was generated based on a superdense coding protocol and the QM encoding 144.

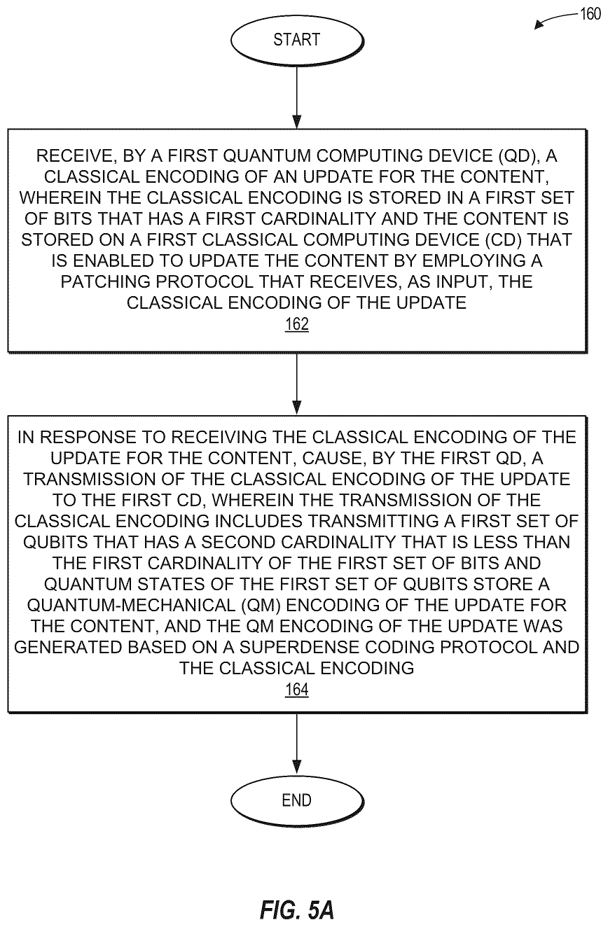

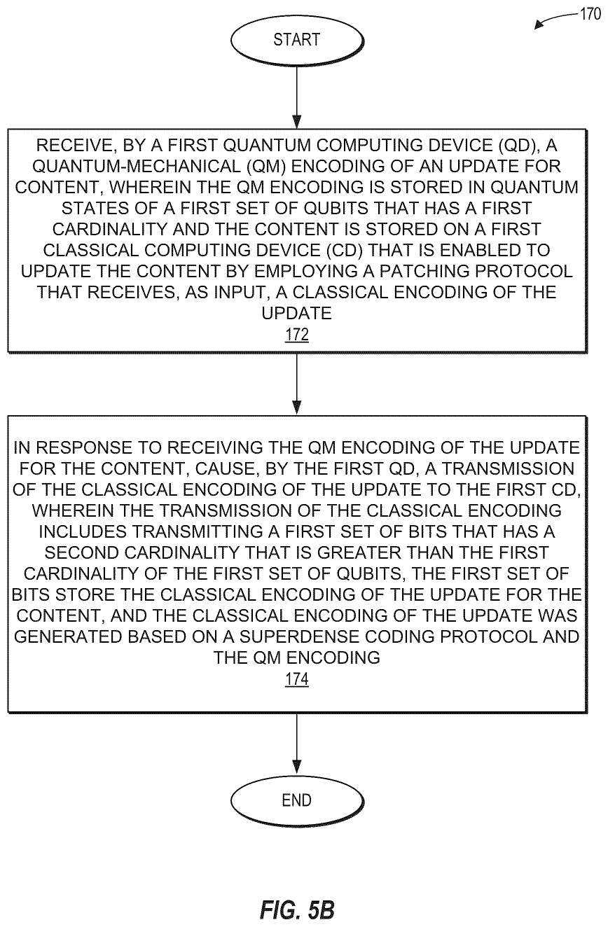

FIG. 5A provides a flowchart of a simplified method for providing updates for content via superdense coding, according to one example. Method 160 begins, after a start block, at block 162, where a classical encoding (e.g., classical encoding 144 of FIG. 4) of an update for the content (e.g., content 74 of FIG. 2) is received at a first quantum computing device (QD) (e.g., first QD 42 of FIG. 2). The classical encoding may be stored in a first set of bits (e.g., bits included in the first classical file 40 of FIG. 2). The first set of bits (e.g., first set of bits 142 of FIG. 4) has a first cardinality. The content may be stored on a first classical computing device (CD) (e.g., third CD 72 of FIG. 2). The first CD may be enabled to update the content by employing a patching protocol that receives, as input, the classical encoding of the update.

At block 164, and in response to receiving the classical encoding of the update for the content, the first CD may cause a transmission of the classical encoding of the update to the first CD. The transmission of the classical encoding includes transmitting a first set of qubits (e.g., first set of qubits 138 of FIG. 4). The first set of qubits may have a second cardinality that is less than the first cardinality of the first set of bits. Quantum states of the first set of qubits may store a quantum-mechanical (QM) encoding of the update for the content. The QM encoding of the update may have been generated based on a superdense coding protocol and the classical encoding.

Although not shown in FIG. 5A, method 160 may further include, generating, by the first QD, the QM encoding of the update for the content based on the superdense coding protocol and the classical encoding. Generating the QM encoding of the update for the content may include preparing, by the first QD, the quantum states of the first set of qubits based on the superdense coding protocol and the first set of qubits such that the quantum states of the first set of qubits store the QM encoding.

Causing the transmission of the classical encoding of the update to the first CD may include transmitting, over at least a first quantum communication channel (QCC) (e.g., first QCC 46 of FIG. 2), the first set of qubits from the first QD to a second QD (e.g., second QD 50 of FIG. 2). The first QD may have prepared the quantum states of the first set of qubits. The second QD is enabled to cause the transmission of the classical encoding of the update to the first CD. A first party (e.g., content distributor 34 of FIG. 2) may operate the first QD. A second party (e.g., first client 62 of FIG. 2) may operate both the second QD and the first CD. A classical communication network communicatively (e.g., classical communication network 70 of FIGS. 1 and 2) couples the second QD and the first CD. The first QD may be isolated from the classical communication network.

In some embodiments, causing the transmission of the classical encoding of the update to the first CD may further include generating, by the first QD and based on the superdense coding protocol, the QM encoding of the update for the content. The first QD may register the first set of qubits. The first set of qubits may be transmitted over the first QCC and from the first QD to the second QD. The second QD may be coupled to a third QD (e.g., third QD 64 of FIG. 2), via a second QCC (e.g., second QCC 60 of FIG. 2). The third QD may be communicatively coupled to the first CD via a classical communication network or other classical communication means. The first QD may be isolated from the classical communication network. A communicative coupling between the first QD and the second QD may be enabled only by the first QD such that a communicative coupling between the first QD and the first CD requires at least one of the first QCC and the second QCC. The first set of qubits may be transmitted via the second QCC and from the second QD to the third QD.

In other embodiments, causing the transmission of the classical encoding of the update to the first CD may further include preparing, by the second QD, quantum states of a second set of qubits such that the second set of qubits stores the QM encoding of the update for the content. The second set of qubits may be transmitted over the second QCC and from the second QD to the third QD.

The content may include at least one of an executable application installed on the first CD or an operating system (OS) installed on the first CD. The update for the content may be and/or include a security patch for the content. The second cardinality of the first set of qubits may be one-half the first cardinality of the first set of bits.

FIG. 5B provides a flowchart of a another simplified method for providing updates for content via superdense coding, according to one example. The other method 170 begins, after a start block, at block 172, where a quantum-mechanical (QM) encoding (e.g., Qm encoding 146 of FIG. 4) of an update for content (e.g., content 74 of FIG. 2) may be received at a first quantum computing device (QD) (e.g., third QD 64 of FIG. 2). The QM encoding may be stored in quantum states of a first set of qubits (e.g., the first set of qubits 142 of FIG. 4). The first set of qubits may have a first cardinality. The content may be stored on a first classical computing device (CD) (e.g., third CD 72 of FIG. 2). The third CD may be enabled to update the content by employing a patching protocol that receives, as input, a classical encoding (e.g., classical encoding 144 of FIG. 4) of the update.

At block 174, and in response to receiving the QM encoding of the update for the content, the first QD may cause a transmission of the classical encoding of the update to the first CD. The transmission of the classical encoding may include transmitting a first set of bits (e.g., the first set of bits 142 of FIG. 4). The first set of bits may have a second cardinality that is greater than the first cardinality of the first set of qubits. The first set of bits may store the classical encoding of the update for the content. The classical encoding of the update may have been generated based on a superdense coding protocol and the QM encoding.

Method 170 may further include generating, by the first QD, the classical encoding of the update for the content of the first set of qubits based on the superdense coding protocol and the QM encoding stored in the first set of qubits. Generating the classical encoding of the update may include receiving, by the first QD, the first set of qubits from a first quantum communication channel (QCC) (e.g., the second QCC 60 of FIG. 2). The quantum states of the first set of qubits may be measured at the first QD. Measuring the quantum states of the first set of qubits may be based on the superdense protocol. The first set of bits may be prepared based on results from measuring the quantum states of the first set of qubits such that the first set of qubits store the classical encoding.

Causing the transmission of the classical encoding of the update to the first CD may include receiving, over at least a first quantum communication channel (QCC) (e.g., the first QCC 46 of FIG. 2 and/or the second QCC 60 of FIG. 2), the first set of qubits at the first QD from a second QD (e.g., the first QD 42 of FIG. 2 and/or the second QD 50 of FIG. 2). The second QD may have prepared the quantum states of the first set of qubits. The first QD may be enabled to cause the transmission of the classical encoding of the update to the first CD. If the second QD is the first QD 42 of FIG. 2, the second QD is isolated from the classical communication network (e.g., classical communication network 70 of FIG. 2). The content may include at least one of an executable application installed on the first CD or an operating system (OS) installed on the first CD. The update for the content may be or may include a security patch for the content. The first cardinality of the first set of qubits may be one-half the second cardinality of the first set of bits. That is, the second cardinality is twice the first cardinality.

Individuals will recognize improvements and modifications to the preferred examples of the disclosure. All such improvements and modifications are considered within the scope of the concepts disclosed herein and the claims that follow.

What is claimed is:

1. A method for updating content, comprising:
receiving, by a first quantum computing device (QD), a classical encoding of an update for the content, wherein the classical encoding is stored in a first set of bits that has a first cardinality and the content is stored on a first classical computing device (CD) that is enabled to update the content by employing a patching protocol that receives, as input, the classical encoding of the update; and
in response to receiving the classical encoding of the update for the content, causing, by the first QD, a transmission of the classical encoding of the update to the first CD, wherein the transmission of the classical encoding includes transmitting a first set of qubits that has a second cardinality that is less than the first cardinality of the first set of bits and quantum states of the first set of qubits store a quantum-mechanical (QM) encoding of the update for the content, and the QM encoding of the update was generated based on a superdense coding protocol and the classical encoding.

2. The method of claim 1, further comprising:
generating, by the first QD, the QM encoding of the update for the content based on the superdense coding protocol and the classical encoding.

3. The method of claim 2, wherein generating the QM encoding of the update for the content comprises:
preparing, by the first QD, the quantum states of the first set of qubits based on the superdense coding protocol and the first set of qubits such that the quantum states of the first set of qubits store the QM encoding.

4. The method of claim 1, wherein causing the transmission of the classical encoding of the update to the first CD comprises:
transmitting, over at least a first quantum communication channel (QCC), the first set of qubits from the first QD to a second QD, wherein the first QD prepared the quantum states of the first set of qubits and the second QD is enabled to cause the transmission of the classical encoding of the update to the first CD.

5. The method of claim 4, wherein a first party operates the first QD, a second party operates both the second QD and the first CD, and a classical communication network communicatively couples the second QD and the first CD.

6. The method of claim 5, wherein the first QD is isolated from the classical communication network.

7. The method of claim 4, wherein causing the transmission of the classical encoding of the update to the first CD further comprises:
generating, by the first QD and based on the superdense coding protocol, the QM encoding of the update for the content, by registering the first set of qubits; and
transmitting, over the first QCC, the first set of qubits from the first QD to the second QD, wherein the second QD is coupled to a third QD via a second QCC, the third QD is communicatively coupled to the first CD via a classical communication network, the first QD is isolated from the classical communication network, and a communicative coupling between the first QD and the second QD is enabled only by the first QD such that a communicative coupling between the first QD and the first CD requires at least one of the first QCC and the second QCC.

8. The method of claim 7, wherein causing the transmission of the classical encoding of the update to the first CD further comprises:
transmitting, over the second QCC, the first set of qubits from the second QD to the third QD.

9. The method of claim 7, wherein causing the transmission of the classical encoding of the update to the first CD further comprises:
preparing, by the second QD, quantum states of a second set of qubits such that the second set of qubits stores the QM encoding of the update for the content; and
transmitting, over the second QCC, the second set of qubits from the second QD to the third QD.

10. The method of claim 1, wherein the content includes at least one of an executable application installed on the first CD or an operating system (OS) installed on the first CD, and the update for the content includes a security patch for the content.

11. The method of claim 1, wherein the second cardinality is one-half the first cardinality.

12. A method for updating content, comprising:
receiving, by a first quantum computing device (QD), a quantum-mechanical (QM) encoding of an update for content, wherein the QM encoding is stored in quantum states of a first set of qubits that has a first cardinality and the content is stored on a first classical computing device (CD) that is enabled to update the content by employing a patching protocol that receives, as input, a classical encoding of the update; and
in response to receiving the QM encoding of the update for the content, causing, by the first QD, a transmission of the classical encoding of the update to the first CD, wherein the transmission of the classical encoding includes transmitting a first set of bits that has a second cardinality that is greater than the first cardinality of the first set of qubits, the first set of bits store the classical encoding of the update for the content, and the classical encoding of the update was generated based on a superdense coding protocol and the QM encoding.

13. The method of claim 12, further comprising:
generating, by the first QD, the classical encoding of the update for the content of the first set of qubits based on the superdense coding protocol and the QM encoding stored in the first set of qubits.

14. The method of claim 13, wherein generating the classical encoding of the update comprises:
receiving, by the first QD, the first set of qubits from a first quantum communication channel (QCC);
measuring, by the first QD, the quantum states of the first set of qubits based on the superdense protocol; and
preparing the first set of bits based on results from measuring the quantum states of the first set of qubits such that the first set of qubits store the classical encoding.

15. The method of claim 12, wherein causing the transmission of the classical encoding of the update to the first CD comprises:
receiving, over at least a first quantum communication channel (QCC), the first set of qubits at the first QD from a second QD, wherein the second QD prepared the quantum states of the first set of qubits and the first QD is enabled to cause the transmission of the classical encoding of the update to the first CD.

16. The method of claim 15, wherein a first party operates the second QD, a second party operates both the first QD and the first CD, and a classical communication network communicatively couples the first QD and the first CD.

17. The method of claim 16, wherein the second QD is isolated from the classical communication network.

18. The method of claim 12, wherein the content includes at least one of an executable application installed on the first CD or an operating system (OS) installed on the first CD, and the update for the content includes a security patch for the content.

19. The method of claim 12, wherein the second cardinality is twice the first cardinality.

20. A quantum computing device, comprising:
a first set of qubits that has a second cardinality;
a system memory; and
a processor device communicatively coupled to the system memory, the processor device to:
receive a classical encoding of an update for content, wherein the classical encoding is stored in a first set of bits that has a first cardinality that is greater than the second cardinality of the first set of qubits and the content is stored on a first classical computing device (CD) that is enabled to update the content by employing a patching protocol that receives, as input, the classical encoding of the update; and
in response to receiving the classical encoding of the update for the content, cause a transmission of the classical encoding of the update to the first CD, wherein the transmission of the classical encoding includes transmitting the first set of qubits and quantum states of the first set of qubits store a quantum-mechanical (QM) encoding of the update for the content, and the QM encoding of the update was generated based on a superdense coding protocol and the classical encoding.
